(19) United States
(12) Patent Application Publication
(10) Pub. No.: US 2025/0160563 A1
(43) Pub. Date: May 22, 2025

(54) PIZZA OVEN FOR FIRE PIT

(71) Applicant: Breeo, LLC, Kinzers, PA (US)

(72) Inventors: Amos Alan Allgyer, Gordonville, PA (US); Christopher Boehmer, Shohola, PA (US)

(21) Appl. No.: 18/904,976

(22) Filed: Oct. 2, 2024

Related U.S. Application Data
(60) Provisional application No. 63/587,187, filed on Oct. 2, 2023.

(51) Int. Cl. A47J 33/00; F24B 1/182

(52) U.S. Cl. CPC A47J 33/00; F24B 1/182

(57) ABSTRACT

An oven for a fire pit can be added after the fire in the pit is already burning. The oven can be used to bake pizzas and is then removed so that fire pit can be used as usual. The oven has an upper baking chamber separated from a lower chamber. The lower chamber is vented to the exterior by a large opening in the outer sidewall to control the very high temperature coming off of the fire pit. This opening also allows additional firewood or other fuel to be added to the fire without removing the fire pit. The baking chamber is thus spaced above the top of the fire pit by the height of the lower chamber. The baking chamber has a double exterior wall.

### CROSS REFERENCE TO RELATED APPLICATIONS

This application claims the benefit of U.S. Provisional Patent Application No. 63/587,187 filed Oct. 2, 2023; the disclosures of which are incorporated herein by reference.

### BACKGROUND OF THE DISCLOSURE

### 1. Technical Field

The disclosure relates to cooking ovens and, more particularly, to a pizza oven that is used with a fire pit. Specifically, the disclosure relates to a pizza oven that can be placed on and removed from a wood-fueled outdoor fire pit to provide the heat for baking pizzas and other items.

### 2. Background Information

People enjoy burning campfires in outdoor fire pits. Double-walled low smoke or smokeless fire pits are particularly enjoyable because the minimal smoke does not bother those around the fire pit and does not bother neighbors. People also enjoy using outdoor pizza ovens because the oven can be used at a higher temperature than indoor conventional ovens. Outdoor pizza ovens are used at temperatures ranging from 700 degrees Fahrenheit to 1000 degrees Fahrenheit. One drawback with such pizza ovens is they can take a long time to reach the high temperature and can produce smoke during the warm-up period.

### SUMMARY OF THE DISCLOSURE

The disclosure provides a pizza oven that is used with an outdoor fire pit. The disclosure provides a pizza oven that can be placed on top of burning fire pit so that the fire pit may be enjoyed prior to cooking pizzas and so that the fire pit can reach a high steady state temperature before the addition of the pizza oven.

The disclosure provides a pizza oven having a plurality of feet that help center the pizza oven on the fire pit and retain the pizza oven by preventing it from readily sliding laterally off of the fire pit. The feet have angled surfaces to help with the positioning. The feet project into the top of the fire pit inwardly of the upper fire pit wall or upper fire pit flange.

The disclosure provides a pizza oven with handles on the sides to accommodate lifting the pizza oven onto and from the fire pit.

The disclosure provides an embodiment of a pizza oven having an upper baking chamber separated from a lower chamber that gathers the heat with a support wall defined by a plurality of ribs supported by a common wall. The front of the lower chamber is vented to the exterior by a large opening in the outer sidewall to control the very high temperature coming off of the fire pit. The sidewall closes off the rear and sides of the lower chamber to direct heat upwardly. This opening also allows additional firewood or other fuel to be added to the fire without removing the fire pit. The baking chamber is thus spaced above the top of the fire pit by the height of the lower chamber. In the exemplary configuration, the baking chamber has a double exterior wall and top wall. In the exemplary configuration, a support wall separates the baking chamber from the lower chamber and provides support for a pizza stone or other baking tray. The support wall is defined by hollow ribs and common wall that define a plurality of holes to allow the hot gases to pass into the baking chamber below the stone. The common wall defines one large rear opening to allow a majority of the heat and combustion products into the rear of the baking chamber.

The disclosure provides a combination of a wood-fired, smokeless fire pit with a pizza oven. The pizza oven can be placed onto the fire pit after the fire is established and burning clean wherein the pizza oven rapidly heats and is ready to use.

The individual features described below may be combined in different combinations than specifically described below to form different configurations of the device of the disclosure. The locations and the numbers of the items can be changed. The preceding non-limiting aspects of the disclosure, as well as others, are more particularly described below. A more complete understanding of the devices, assemblies, and methods can be obtained by reference to the accompanying drawings, which are not intended to indicate relative size and dimensions of the assemblies. In those drawings and the description below, like numeric designations refer to components of like function. Specific terms used in that description are intended to refer only to the particular structure of the embodiments selected for illustration in the drawings, and are not intended to define or limit the scope of the disclosure.

### BRIEF DESCRIPTION OF THE DRAWINGS

FIG. 1 is a perspective view of an exemplary embodiment of a pizza oven that is used with a fire pit.

FIG. 2 is a front view thereof.

FIG. 3 is a rear view thereof.

FIG. 4 is a left side view thereof.

FIG. 5 is a right side view thereof.

FIG. 6 is a top plan view thereof.

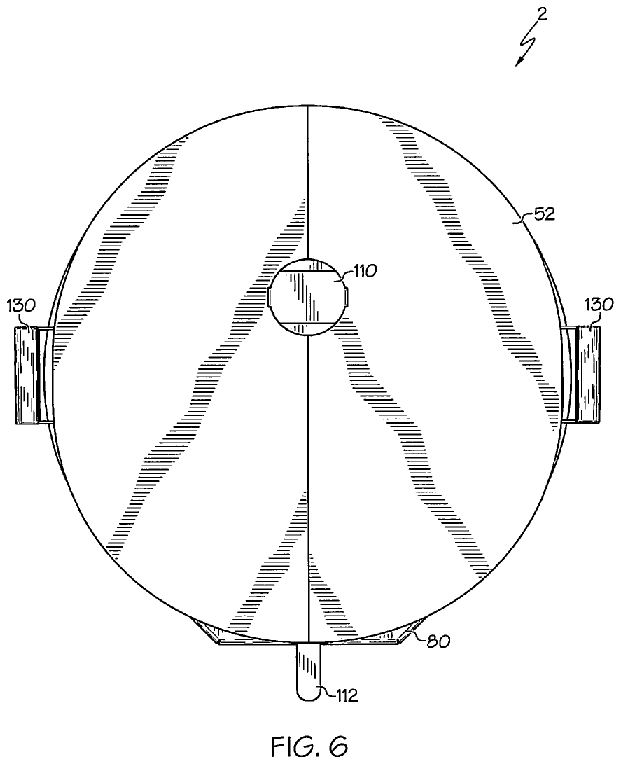

FIG. 7 is a bottom plan view thereof.

FIG. 8 is a front elevation view of the pizza oven mounted on top of a fire pit.

FIG. 9 is a section view taken along line 9-9 of FIG. 8.

FIG. 10 is a section view taken through the assembly shown in FIG. 9.

### DETAILED DESCRIPTION OF THE DISCLOSURE

This description of exemplary embodiments is intended to be read in connection with the accompanying drawings, which are to be considered part of the entire written description. The drawing figures are not necessarily to scale and certain features may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “joined,” “connected,” and “interconnected,” refer to a relationship wherein structures are secured or attached to one another either directly or indirectly through intervening structures, as well as both movable or rigid attachments or relationships, unless expressly described otherwise.

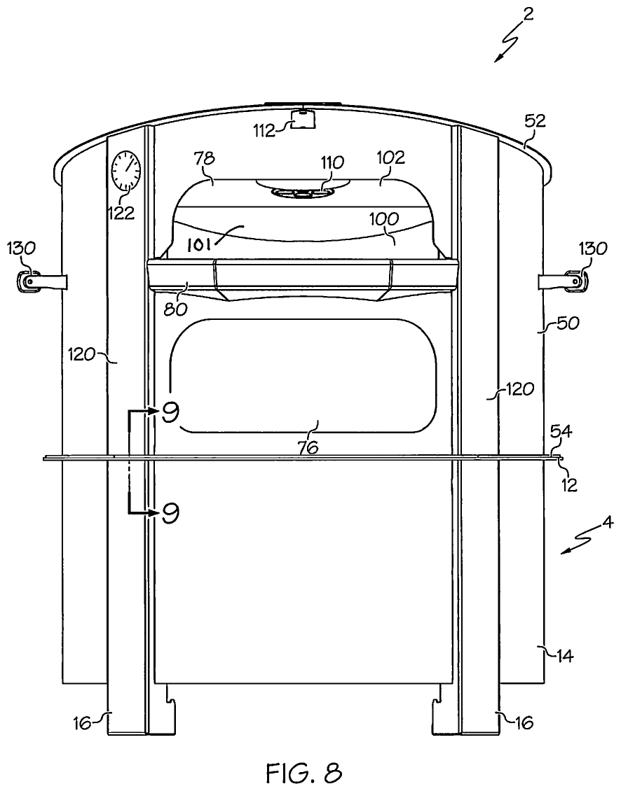

An exemplary embodiment of the pizza oven of the disclosure is indicated generally by the number 2 in the accompanying drawings. Pizza oven 2 is used with a fire pit 4 as shown in FIGS. 8-10. The particular fire pit 4 depicted in the drawings is exemplary. Pizza oven 2 can be used with a variety of fire pits 4 including both regular, single-wall fire pits and smokeless, double-wall fire pits 4. The exemplary configuration in the drawings is a smokeless fire pit 4 having air flow channels 6 that deliver heated air to the top of a fire box 8 through air outlets 10. This fire pit 4 has an upper wall 12 that closes off the top of air flow channel 6. Upper wall 12 can extend inwardly over a portion of fire box 8 and extend outwardly beyond the outer sidewall 14. The air can be drawn in through openings at the bottom of air flow channel 6 or through inlets defined by outer sidewall 14. Legs 16 lift the bottom wall 18 above the support surface. Pizza oven 2 can be used on a fire pit 4 that matches its diameter or on larger fire pits by using a conversion ring between the fire pit and pizza oven 2.

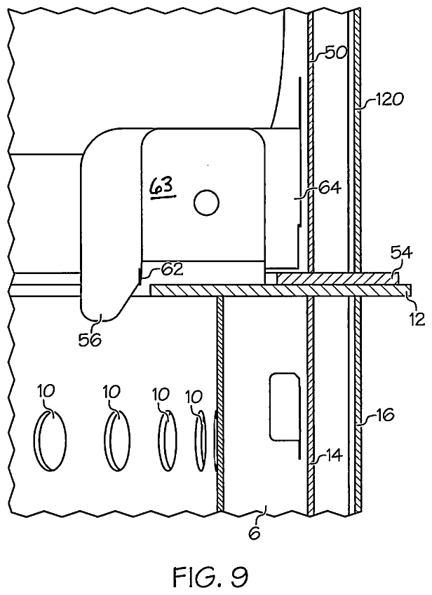

Pizza oven 2 generally includes an outer sidewall 50, a top wall 52, and a ring-shaped mounting wall 54. A plurality of feet 56 project down from inside the inner edge of ring-shaped mounting wall 54. In the exemplary embodiment, each foot 56 has a bottom edge 58 and an angled wall 60 that extends from a lower end of an outer edge 62 to the outer end of bottom edge 58 (see FIG. 9). When pizza oven 2 is being placed onto fire pit 4, feet 56 help center pizza oven 2 and provide feedback to the person positioning pizza oven 2 as they slide along upper wall 12 and fall over the inner edge of upper wall 12. Angled walls 60 help to self-center pizza oven 2 on fire pit 4. Feet 56 are carried by supports 63 that are formed by bending up portions of wall 54. Each foot 56 has a mounting body 64 that is either welded to support 63 or connected thereto with a fastener.

Ring-shaped mounting wall 54 is sized to rest on top of upper wall 12 of fire pit 4. In the exemplary configuration, mounting wall 54 has an inner diameter that matches the inner diameter of upper wall 12 of fire pit 4. The outer diameter is smaller as shown in FIG. 9. In other configurations, mounting wall 54 does not have to match the structure onto which pizza oven 2 is being mounted. In the exemplary configuration, mounting wall 54 fits tightly on upper wall 12 so that little hot air leaks out from between the two.

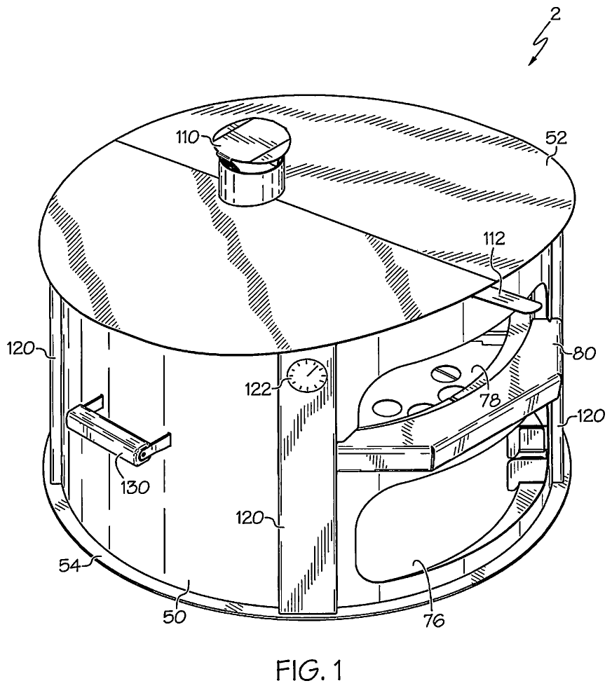

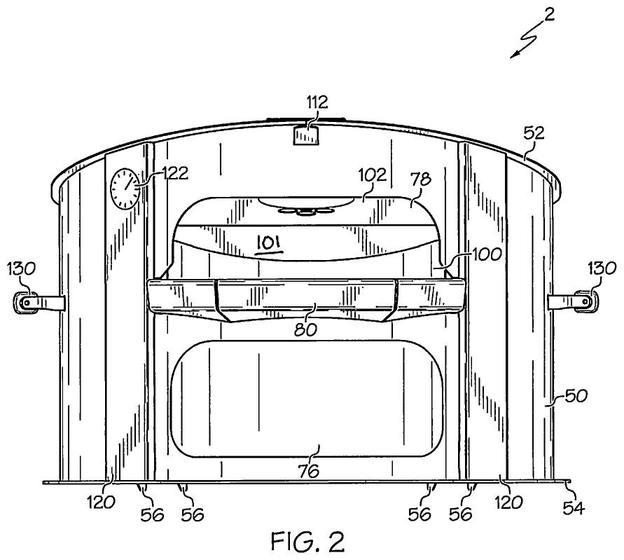

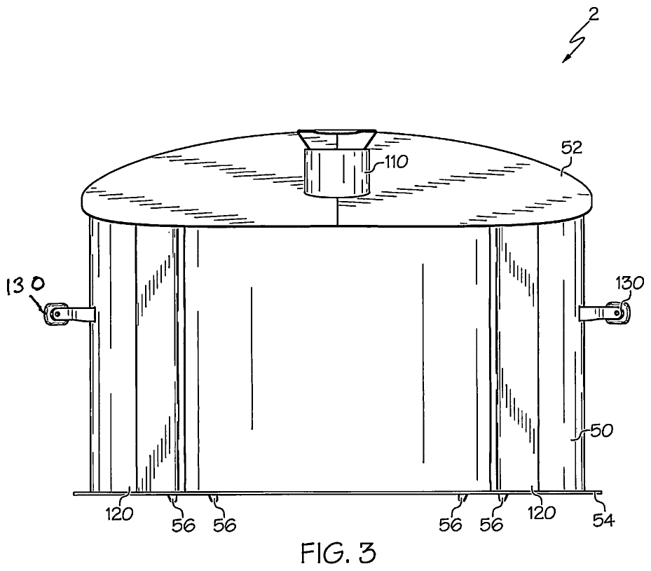

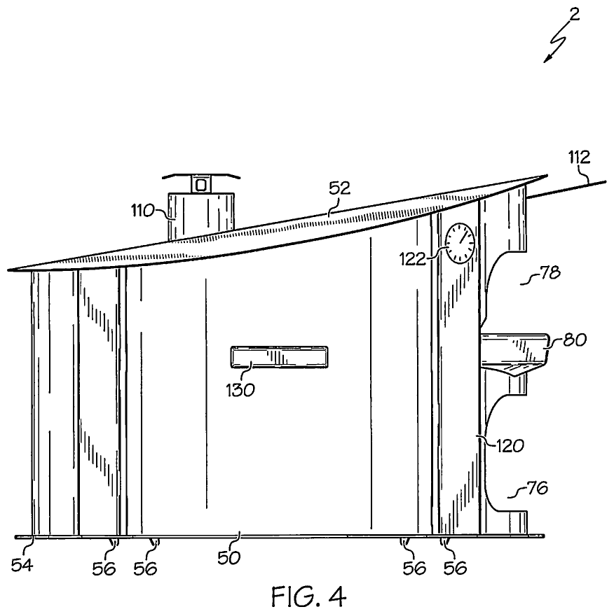

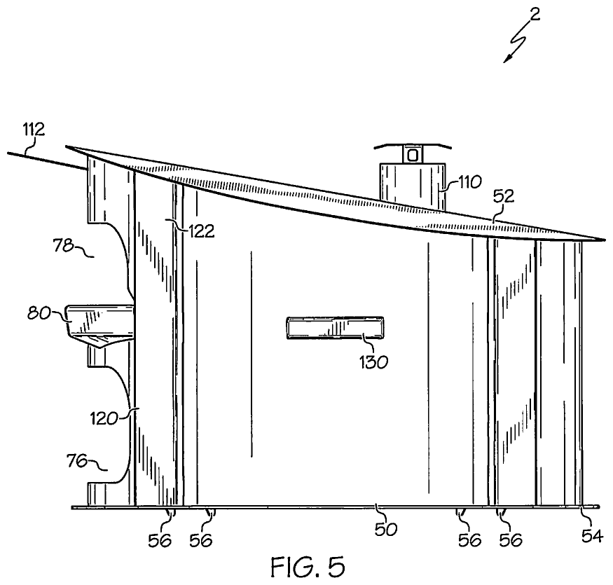

Outer sidewall 50 projects up from mounting wall 54 and supports top wall 52. The space defined inwardly of outer sidewall 50 and top wall 52 is divided into an upper baking chamber 70 and a lower chamber 72 by a support wall 74. Support wall 74 removably carries the pizza stone upon which the pizza is cooked when oven 2 is in use. Outer sidewall 50 defines a first opening 76 to lower chamber 72 that allows a percentage of the heated gases produced by the burning fuel in fire pit 4 to escape. Additional fuel for fire pit 4 can be added through first opening 76. As shown in FIGS. 1-5, outer sidewall 50 is continuous except at first opening 76 such that lower chamber 72 is enclosed to capture the heat and gases being exhausted by the heat source in fire pit 4. Outer sidewall 50 directs these to first opening 76 and upwardly to the support wall 74. Outer sidewall 50 defines a second opening 78 providing access to baking chamber 70. A shelf 80 projects outwardly from outer sidewall 50. The pizza stone is provided in sections that fit through second opening 78 so that the stone can be installed and removed as needed.

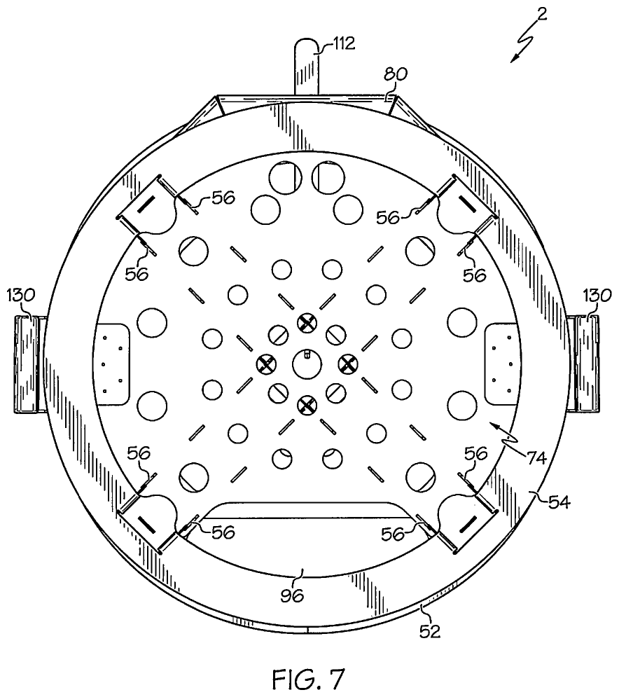

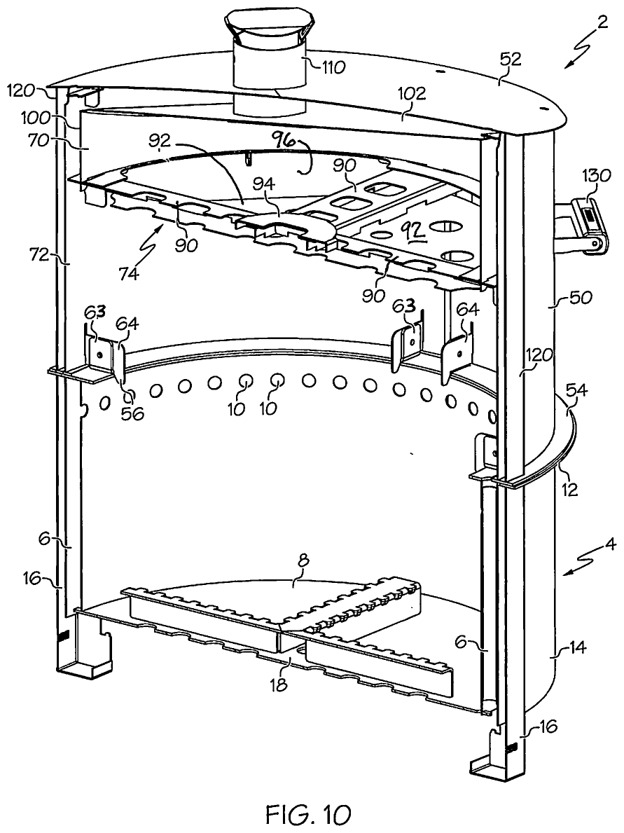

Support wall 74 includes a plurality of hollow ribs 90 connected to and located above a common wall 92. Both ribs 90 and wall 92 define openings (circular openings shown in FIGS. 7 and 10) that allow a portion of the heat and gases from the combustion action in fire pit 4 to enter upper baking chamber 70 from below a pizza stone. These help heat the pizza stone. The pizza stone is carried on top of ribs 90 and hub 94 above common wall 92. However, wall 74 limits the amount of heat and directs most of the heat and gas flow to the rear of baking chamber 70 where it rolls over the pizza being baked to melt cheese and cook toppings. Hollow ribs 90 project from a central hub 94. Each hollow rib 90 has an upper wall spaced from wall 92 by sidewalls. In the exemplary configuration, four hollow ribs 90 are provided. Ribs 90 support a pizza or baking stone or other removable baking tray within upper baking chamber 70. Common wall 92 defines a large (over half of the area of the portion of wall 92 between ribs 90) rear opening 96 between two sets of feet 56 (FIG. 7) that allows a majority of the heat and combustion gases to flow into the rear of baking chamber 70. Typical pizza ovens burn wood or coal within the baking chamber itself with the flames and combustion products heating the top wall of the baking chamber so that the top of the pizza being baked is heated from heat radiating from the top wall. The large opening 96 in common wall 92 mimics having the fire at the rear or side of the baking chamber by allowing a large flow of heat and combustion gases to flow into the rear of baking chamber 70 where it flows over the pizza being baked to melt cheese and cook toppings.

An inner sidewall 100 extends around baking chamber 70. Inner sidewall 100 is spaced inwardly from outer sidewall 50 to define an air gap between the two. Additionally, an inner top wall 102 spaced from top wall 52 defines the top of baking chamber 70. Inner top wall 102 is angled upwardly from rear to front so that the rear of baking chamber 70 has a height that is less than the height at the front of baking chamber 70. A rear portion 101 of inner top wall 100 above rear opening 96 is further angled down to direct upwardly moving gases and heat forwardly and to angle radiant energy over an item being cooked.

An adjustable chimney vent or flue 110 extends down into baking chamber 70 and up through top wall 52. A control arm 112 extends out the front of pizza oven 2 to allow the user to adjust the size of the vent openings provided by chimney vent 110 by sliding or rotating a damper across the openings.

Pizza oven 2 includes vertical columns 120 that match the size and shape of legs 16. Columns 120 increases the rigidity of oven 2. A thermometer or pyrometer 122 (FIG. 1) can be mounted at the top of one of these columns 120 with its sensor configured to sense the temperature inside baking chamber 70 to provide the user with the internal temperature. Each column 120 has a front wall and two sidewalls. Portions of the sidewalls can pass through slots defined by outer sidewall 50 to function as mounting body 64 for feet 56. These portions are also used to mount columns 120 to oven 2.

Handles 130 are connected to outer sidewall 50 to allow pizza oven 2 to be placed by holding both handles and carried at one's side by using one handle 130.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Modifications and alterations of those embodiments will be apparent to one who reads and understands this general description. The present disclosure should be construed as including all such modifications and alterations insofar as they come within the scope of the appended claims or equivalents thereof. Throughout the description and claims of this specification the words “comprise” and “include” as well as variations of those words, such as “comprises,” “includes,” “comprising,” and “including” are not intended to exclude additives, components, integers, or steps.

1. An oven assembly for cooking food; the assembly comprising:
a fire pit having a sidewall and an upper surface;
an oven removable carried on the fire pit;
the oven including an outer sidewall and a top wall;
a support wall below the top wall;
a lower chamber defined below the support wall inwardly of the outer sidewall;
an upper baking chamber defined above the support wall and below the top wall;
a rear portion of the support wall defining a rear opening between the lower chamber and the upper baking chamber;
the outer sidewall having a front portion defining a first opening and a second opening;
the support wall being located between the first and second openings; and
the outer sidewall closing the lower chamber opposite and to both sides of the first opening.

2. The assembly of claim 1, wherein the fire pit includes an upper wall that defines the upper surface; the oven having a lower ring-shaped mounting wall that rests on the upper wall.

3. The assembly of claim 2, wherein the upper flange has an inner diameter and the ring-shaped mounting wall has an inner diameter that is the same as the inner diameter of the upper flange.

4. The assembly of claim 2, wherein the oven includes a plurality of feet that extend inwardly of an inner edge of the upper wall of the fire pit.

5. The assembly of claim 1, wherein the oven includes an inner sidewall above the support wall and an inner top wall below the top wall; the inner sidewall being spaced inwardly of the outer sidewall; and the inner top wall being spaced downwardly from the top wall.

6. The assembly of claim 5, wherein the inner top wall is tilted from rear to front with a rear portion of the inner top wall being lower than a front portion.

7. The assembly of claim 1, wherein the support wall defines a plurality of openings.

8. The assembly of claim 1, further comprising a shelf projecting outwardly of the outer sidewall below the second opening.

9. The assembly of claim 1, further comprising an adjustable chimney vent extending through the top wall.

10. An oven assembly for cooking food on a fire pit; the assembly comprising:
an oven body including an outer sidewall and a top wall;
a support wall below the top wall;
a lower chamber defined below the support wall inwardly of the outer sidewall;
an upper baking chamber defined above the support wall and below the top wall;
a rear portion of the support wall defining a rear opening between the lower chamber and the upper baking chamber;
the outer sidewall having a front portion defining a first opening and a second opening;
the support wall being located between the first and second openings; and
the outer sidewall closing the lower chamber opposite and to both sides of the first opening.

11. The assembly of claim 10, wherein the oven body has a lower ring-shaped mounting wall adapted to rest on a fire pit.

12. The assembly of claim 11, wherein the oven body includes a plurality of feet having portions that extend inwardly of and below an inner edge of the ring-shaped mounting wall.

13. The assembly of claim 12, wherein each foot has a mounting body connected to a support that is connected to the ring-shaped mounting wall.

14. The assembly of claim 10, wherein the oven includes an inner sidewall above the support wall and an inner top wall below the top wall; the inner sidewall being spaced inwardly of the outer sidewall; and the inner top wall being spaced downwardly from the top wall.

15. The assembly of claim 14, wherein the inner top wall is tilted from rear to front with a rear portion of the inner top wall being lower than a front portion.

16. The assembly of claim 10, wherein the support wall defines a plurality of openings.

17. The assembly of claim 10, further comprising a shelf projecting outwardly of the outer sidewall below the second opening.

18. The assembly of claim 10, further comprising an adjustable chimney vent extending through the top wall.

19. The assembly of claim 10, further comprising first and second handles carried on opposite sides of the outer sidewall.

20. The assembly of claim 10, further comprising a plurality of columns carried by the outer sidewall; each of the columns having a lower portion that extends inwardly and below a lower edge of the outer sidewall to function as a mounting foot for the oven.
